(19) United States
(12) Patent Application Publication
(10) Pub. No.: US 2022/0363474 A1
(43) Pub. Date: Nov. 17, 2022

(54) EJECTOR ACTUATION OF REFUSE VEHICLE TAILGATE

(71) Applicant: The Heil Co., Chattanooga, TN (US)

(72) Inventors: Mark Fraas, Centre, AL (US); Michael Shane Peek, Pisgah, AL (US); Bryan Stewart, Chattanooga, TN (US); Eric Evans, Fort Payne, AL (US)

(21) Appl. No.: 17/741,047

(22) Filed: May 10, 2022

Related U.S. Application Data
(60) Provisional application No. 63/187,086, filed on May 11, 2021.

(51) Int. Cl. B65F 3/20; B65F 3/28; B65F 3/22

(52) U.S. Cl. CPC B65F 3/201; B65F 3/28; B65F 3/22

(57) ABSTRACT

A refuse vehicle body includes a tailgate coupled to the body. The tailgate is movable between closed and open positions. An ejector is deployed in the body and configured to translate between forward and rearward positions. An actuator is configured to translate the ejector between the forward and rearward positions and is further configured to provide an actuation force that moves the tailgate from the closed position towards the open position and thereby at least partially opens the tailgate.

### CROSS REFERENCE TO RELATED APPLICATION

This application claims priority to U.S. Provisional Patent Application No. 63/187,086, filed on May 11, 2021, which is incorporated herein by reference in its entirety.

### FIELD OF THE INVENTION

Disclosed embodiments relate generally to refuse collection vehicles and more particularly to a refuse vehicle employing an ejector actuated tailgate.

### BACKGROUND INFORMATION

Refuse vehicles have long serviced homes and businesses in urban, residential, and rural areas. Collected waste is commonly transported to a landfill, an incinerator, a recycling plant, or some other facility. After collection in a hopper (such as in a side or front load vehicle), the waste is generally compacted into a storage (or refuse) chamber (often in the rear of the vehicle). Such compaction reduces the volume of the refuse and increases the carrying capacity of the vehicle. An ejector is commonly used to compact the waste. Upon opening the tailgate at a landfill (or other facility), the same ejector is also commonly used to eject the waste from the rear of the vehicle.

In various common vehicle configurations, the tailgate is hinged at the top, rear of the storage chamber and is opened and closed using linear hydraulic actuators deployed on both sides of the vehicle. The tailgate generally further includes a locking assembly to lock the tailgate closed. The locking assembly is intended to seal the storage chamber and withstand the ejector compaction forces. When emptying the refuse vehicle, the tailgate is first unlocked and opened. The ejector then forces the waste out the rear of the vehicle.

While such refuse vehicles have long been serviceable, there is a need for further improvements. For example, hydraulic system leakage is believed to be damaging to the environment. Hydraulic systems (such as hydraulic tailgate actuators) also tend to be expensive, difficult to service, and can be more prone to failure in cold temperatures. For these and other reasons, there is a developing demand for all electric or partially electric refuse vehicles that eliminates hydraulic actuators.

### SUMMARY

Refuse vehicles are disclosed. One aspect of the present disclosures features a vehicle body including a tailgate coupled to the body. The tailgate is movable (e.g., rotatable) between a closed position and an open position. An ejector is deployed in the body and configured to translate between forward and rearward positions in a direction parallel to a longitudinal axis of the body. An actuator is configured to translate the ejector between the forward and rearward positions in the body. The actuator is further configured to provide an actuation force that moves the tailgate from the closed position towards the open position and thereby at least partially opens the tailgate.

In some embodiments, the tailgate, the ejector, and the actuator are configured such that the actuator provides a sole actuation force that moves the tailgate from the closed position towards the open position. In some embodiments, the ejector is configured cause the actuation force to be applied to the tailgate in response to translation of the ejector towards the rearward position beyond an intermediate position. In some embodiments, the actuation force is applied to the tailgate only when the ejector is translated towards the rearward position beyond an intermediate position. In some embodiments, the actuation force is applied to the tailgate only when the ejector is translated towards the rearward position beyond an intermediate position.

In some embodiments, the ejector is configured to compact the refuse in the body into contact with the tailgate, thereby causing at least a portion of the actuation force to be applied to the tailgate through the refuse in response to translation of the ejector beyond the intermediate position. In some embodiments, the tailgate is hinged to the body and rotatable between the closed and the open positions; and the body further includes a winch mounted on a top exterior side of the body, the winch including an electric actuator and a cable connected to the tailgate, the winch configured to provide a supplementary actuation force to the tailgate through the cable to rotate the tailgate towards the open position.

In some embodiments, the ejector is configured to cause the tailgate to be moved to the open position in response to translation of the ejector to the rearward position. In some embodiments, the actuator is an electrically powered linear actuator. In some embodiments, the tailgate is hinged to the body and rotatable between the closed and the open positions. In some embodiments, the ejector is configured to: 1) compact refuse in a storage container when the tailgate is in the closed position, and 2) eject the refuse from the storage container when the tailgate is at least partially open in response to translation of the ejector towards the rearward position. In some embodiments, the vehicle further includes: a hopper configured to receive refuse; and a storage container configured to store compacted refuse, wherein the ejector is configured to transfer the refuse from the hopper to the storage container, compact the refuse in the storage container, and eject the compacted refuse from the storage container. In some embodiments, the vehicle body further includes: a hopper configured to receive refuse; a storage container configured to store compacted refuse; and an auger deployed in the hopper and configured to transfer the refuse from the hopper to the storage container, wherein the ejector is configured to eject the compacted refuse from the storage container. In some embodiments, the vehicle body further includes a locking assembly configured to lock the tailgate in the closed position.

Another aspect of the present disclosure features a vehicle body including a tailgate coupled to the body. The tailgate is movable (e.g., rotatable) between a closed position and an open position. An ejector deployed in the body and configured to translate between forward and rearward positions in a direction parallel to a longitudinal axis of the body. An actuator is configured to translate the ejector between the forward and rearward positions in the body. A tailgate actuation system is configured to transfer force from the actuator, via the ejector, to the tailgate when the ejector is translated towards the rearward position to thereby move the tailgate from the closed position to the open position. The disclosed vehicle bodies may be deployed on a vehicle chassis.

In some embodiments, the tailgate actuation system is configured such that the actuator provides a sole actuation force that moves the tailgate from the closed position towards the open position. In some embodiments, the tailgate actuation system includes a push bar rotatably coupled to the tailgate and the ejector, the push bar configured to transfer the force. In some embodiments, the push bar is configured to transfer the force only when the ejector translates towards the rearward position beyond an intermediate position. In some embodiments, the push bar is a telescoping push bar, and wherein the ejector is configured to collapse the telescoping push bar, thereby causing the collapsed push bar to transfer the force in response to translation of the ejector towards the rearward position beyond the intermediate position.

In some embodiments, wherein the push bar is rotatably coupled to the tailgate and the ejector. In some embodiments, the tailgate actuation system further includes a guide rail translatable in a track, the track on an interior side of the body, and wherein the push bar is rotatably coupled to the tailgate and the guide rail. In some embodiments, the ejector is configured to engage the guide rail, thereby causing the push bar to transfer the force in response to translation of the ejector towards the rearward position beyond an intermediate position. In some embodiments, wherein the push bar is fixed to the ejector. In some embodiments, the tailgate actuation system further includes a push bar link rotatably coupled to the tailgate and to a track rail that is mounted on an interior top of the body; and translation of the ejector towards the rearward position beyond the intermediate position causes the push bar to engage the push bar link thereby causing the push bar and the push bar link to transfer the force.

In some embodiments, the tailgate actuation system includes a cable coupled to the ejector and the tailgate, the cable being configured to transfer the force, wherein the cable is routed along an external top side of the body. In some embodiments, the cable is routed along an external top side of the body. In some embodiments, the cable is routed through at least one spring-biased tensioner pulley, the spring-biased tensioner pulley configured to accommodate translation of the ejector in the rearward position to an intermediate position without causing the cable to apply the force. In some embodiments, the ejector is configured to fully extends the spring-biased tensioner pulley, thereby causing the cable to apply the force in response to translation of the ejector towards the rearward position beyond the intermediate position.

Another aspect of the present disclosure features a refuse vehicle including a chassis; and any of the refuse vehicle bodies disclosed herein on the chassis.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts one example refuse vehicle employing a disclosed ejector actuated tailgate assembly.

FIGS. 2A and 2B (collectively FIG. 2) depict the refuse vehicle of FIG. 1 with the body partially cut-away showing internal ejector embodiments.

FIG. 3A depicts a refuse vehicle with the ejector partially extended and the tailgate partially opened.

FIG. 3B depicts a refuse vehicle with an optional supplementary tailgate actuation mechanism and the tailgate fully opened.

FIGS. 4A-4C (collectively FIG. 4) depict side views of a refuse vehicle with a cabling system coupled to the ejector and the tailgate.

FIGS. 5A-5C (collectively FIG. 5) depict top views of the refuse vehicle shown on FIGS. 4A-4C.

FIGS. 6A-6C (collectively FIG. 6) depict side views of a refuse vehicle including a push bar tailgate actuation system having a telescoping push bar.

FIGS. 7A-7C (collectively FIG. 7) depict side views of a refuse vehicle including a push bar tailgate actuation system with a push bar rotatably coupled to the tailgate.

FIGS. 8A-8C (collectively FIG. 8) depict side views of a refuse vehicle including a push bar tailgate actuation system with a push bar fixed to the ejector.

### DETAILED DESCRIPTION

Disclosed refuse vehicle embodiments are configured to utilize ejector actuator power to open a tailgate. The disclosed vehicle (or vehicle body) embodiments are configured such that the ejector actuator provides an actuation force that moves the tailgate from the closed position towards the open position and thereby at least partially opens the tailgate. In certain advantageous embodiments, the vehicle may be configured so that the ejector actuator provides the sole actuation force that moves the tailgate from the closed to the open positions.

The disclosed vehicles may optionally include a tailgate actuation system that is configured to transfer an actuation force from the actuator, via the ejector, to the tailgate when the ejector is translated towards the rear of the vehicle. The actuation force is operable to move (e.g., rotate) the tailgate from the closed position to the open position. In various embodiments, the tailgate actuation system may include a push bar located between the ejector and the tailgate. In other embodiments, the tailgate actuation system may include a cable coupling the ejector to the tailgate.

In various advantageous embodiments, the tailgate actuation system may optionally be configured such that translation of the ejector towards the rear of the vehicle beyond an intermediate position causes the actuation force to be applied to the tailgate. Moreover, the system may also be configured such that the actuation force is applied to the tailgate only when the ejector is translated beyond an intermediate position.

The disclosed refuse vehicles may advantageously make use of an ejector actuator to open (or partially open) a refuse vehicle tailgate. Use of the ejector actuator to open the tailgate may obviate the need for dedicated tailgate actuators. Reducing the number of required actuators may in turn reduce costs and improve vehicle reliability.

The disclosed embodiments may be particularly well suited for electrically powered refuse vehicles (or an electrically powered vehicle body or body components). Providing a single electrical actuator that is operable to move the ejector and to open the tailgate advantageously eliminates hydraulic actuators and may also reduce vehicle weight and improve energy efficiency.

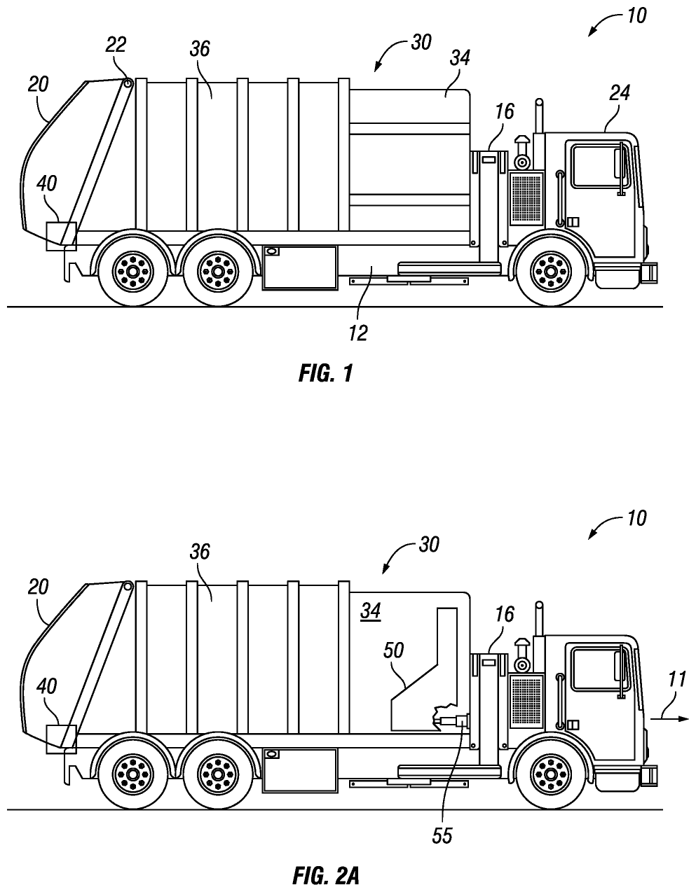

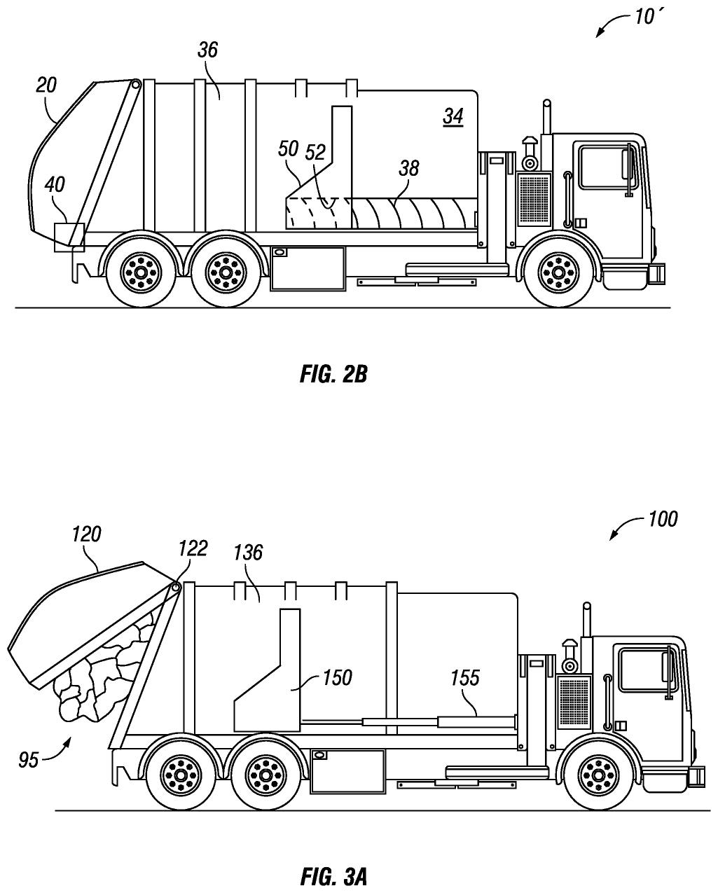

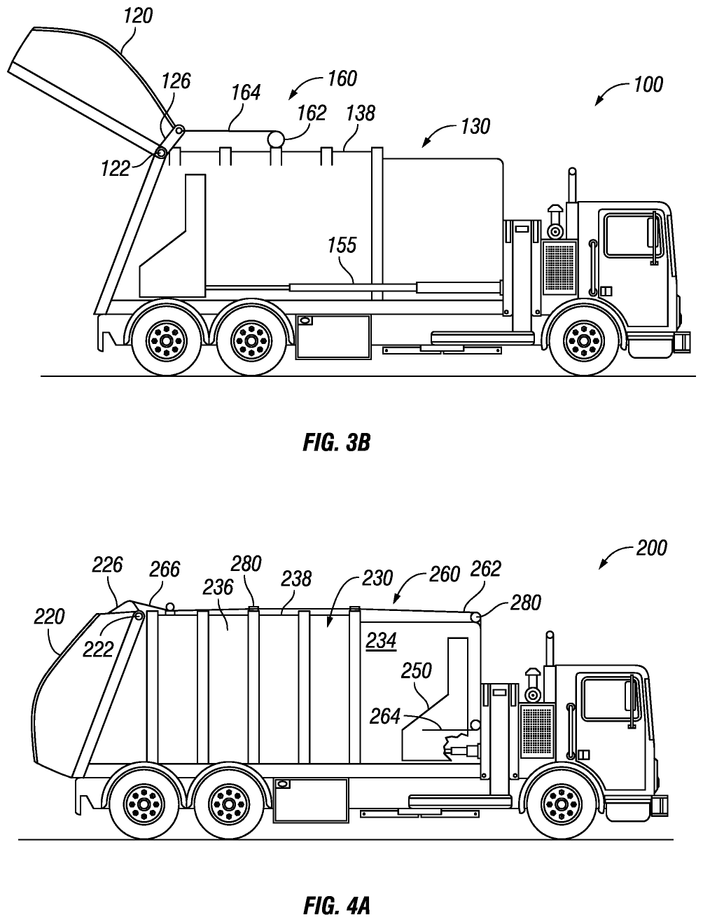

FIG. 1 depicts an example refuse vehicle 10 suitable for employing various ejector actuated tailgate configurations disclosed herein. The depicted vehicle 10 includes a vehicle body 30 and a cab 24 deployed on a chassis (or frame) 12. The vehicle body 30 defines a refuse container, which in the depicted embodiment includes a hopper 34 and a storage container 36 (with the hopper 34 located between the storage container 36 and the cab 24). A tailgate 20 is deployed on a rearward facing end of the body 30 and is configured to open and close the storage container 36 to the outside world. For example, the tailgate 20 may be pinned or hinged at 22 such that the tailgate 20 rotates about the hinge 22 between the closed (as depicted) and open positions (e.g., as depicted in FIG. 3B). As described in more detail below, the tailgate 20 may be opened via actuation of an ejector 50 (FIG. 2).

It will be understood that the disclosed embodiments are not limited to any particular type or style of refuse vehicle. The vehicle may include a sanitation truck, a recycling truck, a garbage truck, a waste collection truck, etc. In FIG. 1, the depicted vehicle 10 is configured as a side loading refuse vehicle; including a side loader assembly 16 configured to load refuse into the hopper from alongside the vehicle. The disclosed embodiments are, of course, not limited in regard to any refuse loading configuration. For example, while not depicted, the vehicle may also be configured as a front loading refuse vehicle including a front loading assembly configured to load refuse from the front of the vehicle. The vehicle may also be configured as a rear loading refuse vehicle, for example, configured for automatic or manual loading of refuse at the rear of the vehicle. Those of ordinary skill will readily appreciate that tailgates in front and side loading vehicles may be similarly constructed, while the tailgate in a rear loading vehicle is generally heavier and includes a built in hopper and compaction unit. Notwithstanding these differences, the disclosed tailgate actuation systems may be suitably configured for use in a rear loading vehicle.

Turning now to FIGS. 2A and 2B, refuse vehicle 10 is shown with a side of the body 30 partially cutaway. As depicted vehicle 10 includes an ejector 50 (also referred to in the industry as an ejector panel, a packer, and a packer panel among other terms) deployed in the body 30. The ejector 50 is configured to translate between forward (retracted) and rearward (extended) positions in a direction substantially parallel with a longitudinal axis 11 of the vehicle 10. The vehicle 10 further includes an actuator 55 configured to translate the ejector 50 between the retracted and extended positions. The actuator 55 may include substantially any suitable actuator, for example, including a linear actuator such as a telescoping hydraulic piston. In certain embodiments, an electrically powered linear actuator may be preferred. A suitable electrically powered linear actuator may include, for example, an electric motor powering a rack and pinion configuration in which the panel is coupled to the rack or an electric motor powering a lead screw or ball screw. The disclosed embodiments are not limited to any particular ejector actuator or actuation mechanism.

It will be appreciated that the ejector 50 is generally retracted towards the front of the vehicle 10 when collecting refuse into the hopper 34, for example via side loader assembly 16 or a top loader assembly. For example, in the embodiment depicted on FIG. 2A, the ejector may be retracted to the front of the hopper 34 (adjacent to the cab). When the hopper 34 is full (or at any other suitable time determined by the operator), the ejector 50 may be extended toward the rear of the vehicle 10 to empty the hopper 34 and compact the refuse in the storage container 36.

In the vehicle embodiment 10′ depicted on FIG. 2B, the ejector may be retracted to the front side of the storage container 36 (between the storage container 36 and the hopper 34). In such embodiments, the hopper 34 includes an auger 38 configured to transfer refuse from the hopper 34 to the storage container 36. The auger 38 may extend rearward through an opening 52 in the ejector 50. Rotation of the auger 38 is intended to empty the hopper 34 as well as compact refuse in the storage container 36. From time to time the ejector 50 may optionally be extended toward the rear of the vehicle 10′ to further compact the refuse in the storage container 36.

When the storage container 36 is full, the tailgate 20 may be opened (as described in more detail below) and the ejector 50 may be fully extended to the rear of the vehicle 10, 10′ to remove the refuse from the vehicle. The actuator 55 is generally configured to provide sufficient actuation force (in the rearward direction) to cause the ejector 50 to compact the refuse when the tailgate 20 is locked in the closed position and to provide at least a portion of the actuation force required to open the tailgate and to eject the refuse from the vehicle when the tailgate 20 is unlocked.

With continued reference to FIGS. 1 and 2, it will be appreciated that various ejector configurations are known in the industry and that the disclosed embodiments are not limited to any particular ejector configuration. For example, the ejector is commonly configured as a panel or blade that may be sized and shaped to extend substantially the full height and width of the storage container 36 as depicted on FIG. 2. In other embodiments, the ejector may be partial height (not extending to the roof of the storage container). As also depicted on FIG. 2B, the vehicle may optionally include an auger 38 configured to transfer refuse from the hopper 34 to the storage container 36 (e.g., through an opening in the ejector). Regardless of the ejector configuration, it will be understood that the ejector and ejector actuator are configured to provide at least a portion of the actuation force required to open the tailgate and to eject refuse from the vehicle.

With continued reference to FIGS. 1 and 2, the vehicle 10, 10′ may further include a tailgate locking mechanism (depicted schematically at 40 on FIGS. 1 and 2) to (lock the tailgate in the closed position. The locking mechanism 40 may advantageously be configured to secure the tailgate 20 in the closed position such that it can withstand compaction forces imparted by the ejector 50 and ejector actuator 55 during a routine compaction operation.

The locking mechanism 40 may include substantially any suitable mechanism known to those of ordinary skill in the art. For example, the locking mechanism may include a manual locking mechanism including a threaded member or a pin deployed on the body (or tailgate) that engages a corresponding aperture on the tailgate (or body). The locking mechanism may alternatively include a powered mechanism in which a pin, screw, or bar engages a corresponding aperture or slot. Such mechanisms may be powered, for example, via hydraulic, electric, or pneumatic power and may be advantageously controlled from the cab. When a locking mechanism is employed it is generally unlocked prior to opening the tailgate. Such unlocking may be initiated, for example, by the vehicle operator. The refuse vehicle may alternatively be configured to automatically unlock the locking mechanism when the tailgate opening procedure is initiated. The disclosed embodiments are not limited with regard to locking and/or unlocking any tailgate locking mechanism.

Turning now to FIGS. 3A-8C, various refuse vehicle embodiments are described in more detail. While these embodiments may differ in various details, they are similar to the embodiments described above in FIGS. 1 and 2 in that the aforementioned ejector actuator is configured to provide at least a portion of the actuation force required to open the tailgate. For example, the actuator and/or the ejector may be configured to transfer the actuation force from the actuator to the tailgate to rotate the tailgate from a closed position towards an open position, thereby at least partially opening the tailgate (e.g., with FIG. 3A depicting a partially open position and FIG. 3B depicting a fully opened position). As described in more detail below, actuation (extension) of the ejector beyond an intermediate position may simultaneously open the tailgate (apply the actuation force to the tailgate) and eject the refuse from the vehicle body. In certain embodiments, the tailgate actuation system may be configured such that the ejector actuator 55 provides the sole actuation force used to open the tailgate. In other embodiments, the vehicle may include a supplementary actuator to assist in fully opening the tailgate.

FIG. 3A depicts refuse vehicle 100 with the ejector 150 and ejector actuator 155 partially extended. In this embodiment, extension of the ejector compacts refuse 95 in the storage container 136 into contact with an inner surface of the tailgate 120 with sufficient force to partially open the tailgate 120. The refuse 95 may be thought of (in a sense) as a “fluid” or “transfer medium” that transfers force from the ejector 150 to the tailgate 120, thereby pivoting (rotating) the tailgate about hinge 122. As the ejector 150 is further extended (via the actuator 155), the tailgate 120 may be further opened via force transfer through the refuse 95. In this way, the refuse 95 is simultaneously ejected from the storage container 136 and used to transfer force to the tailgate 120 for opening the tailgate.

With continued reference to FIG. 3A, it will be appreciated that while force transfer through the refuse 95 may be sufficient to open the tailgate, it may not always be sufficient to maintain the tailgate in the open position (especially as the refuse spills out of the vehicle with continued extension of the ejector 150). It may therefore be advantageous to deploy a ratcheting mechanism or some other mechanism to hold the tailgate 120 in the open position. In this embodiment, such a ratcheting mechanism is deployed, for example, in the hinge 122.

It will also be appreciated that while force transfer through the refuse 95 may be sufficient to partially open the tailgate 120 (as depicted on FIG. 3A), it may not always be sufficient to fully open the tailgate 120 (e.g., because the refuse spills out of the vehicle with continued extension of the ejector 150 and may not provide sufficient upward force to fully open the tailgate). As such it may be advantageous (in certain embodiments) to deploy a secondary tailgate actuation mechanism to assist in fully opening the tailgate. Such a secondary mechanism may advantageously be a low power and low cost system since it is not necessarily required to open the tailgate unassisted.

FIG. 3B depicts one example embodiment of vehicle 100 further including an optional secondary tailgate actuation mechanism 160. In the depicted embodiment, secondary tailgate actuation mechanism 160 includes an electrically powered winch 162 deployed on the roof 138 of the body 130. The winch 162 applies force to the tailgate 120 via a cable 164 that is connected to the tailgate 120 and/or a lever arm or hinge bracket 126 deployed on the tailgate 120 or the hinge 122. Actuation of the winch 162 tensions the cable 164 thereby providing supplemental rotational force to the tailgate 120 (e.g., via the bracket 126) to urge the tailgate 120 towards the open position.

As noted above, mechanism 160 is only intended to provide a supplementary force to open the tailgate 120. As such, a low power, low cost winch 162 may be advantageously utilized. Moreover, while not depicted, the mechanism 160 may advantageously only require a single winch 162 and single cable 164, for example, deployed along on a centerline of the roof 138. It will be appreciated that the ejector actuator 155 and the winch 162 may be truly complementary in the sense that the opening force provided by the actuator 155 (e.g., in FIG. 3A) tends to be at a maximum when the tailgate 120 is closed (or marginally open) as the refuse imparts a near normal force to the tailgate 120. As the tailgate 120 opens, the component of the force normal to the tailgate decreases (and the refuse tends to slide rearward along the tailgate 120). On the other hand, the opening force provided by the winch 162 tends to increase as the tailgate opens and the bracket 126 rotates with the tailgate (the opening force tends to be at a maximum when the bracket is 126 orthogonal to the cable 164). In this way, the force provided by the winch 162 increases as the refuse ejection force decreases.

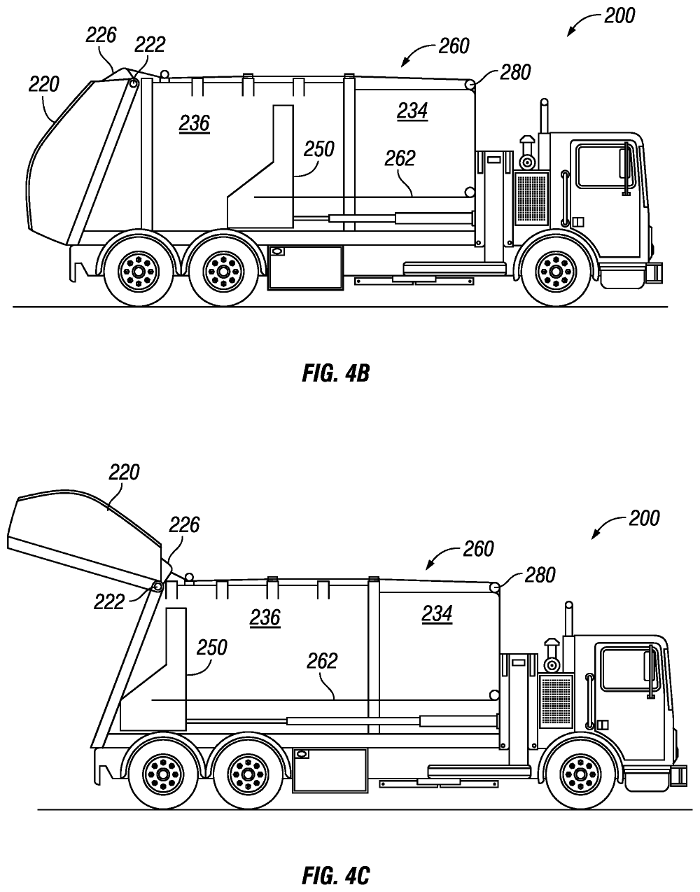

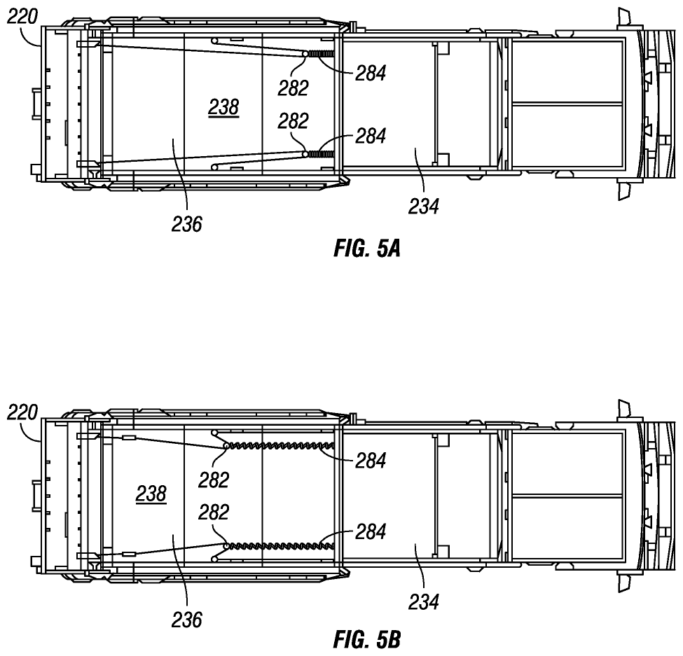

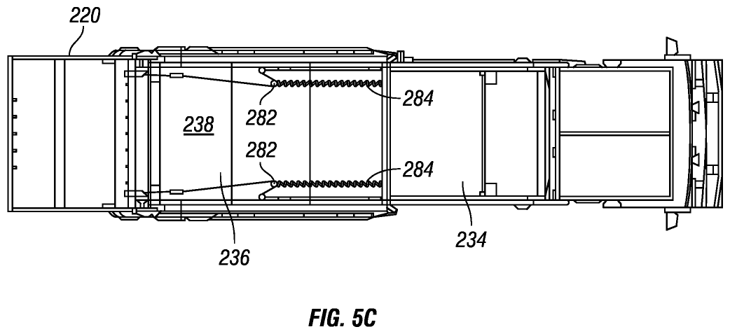

FIGS. 4A-4C and FIGS. 5A-5C depict an alternative refuse vehicle embodiment 200 including a cabling system 260 deployed between the ejector 250 and the tailgate 220. In the depicted embodiment, one end 264 of cable 262 is coupled (e.g., fixed) to a backside or underside of the ejector 250 and the other end 266 of the cable 262 is coupled to the tailgate 220 (e.g., to a lever arm or hinge bracket 226). In the depicted embodiment, the cable 262 is routed up the front, interior side of the hopper 234 and along the roof 238 of the vehicle body 230 to the tailgate 220. As depicted on FIGS. 4A and 5A, the cable 262 may be routed through numerous pulleys 280 deployed at the front of the hopper 234 and on the roof 238.

The tailgate open and close functionality is now described in more detail with respect to FIGS. 4 and 5. In FIGS. 4A and 5A the tailgate 220 is closed and the ejector 250 is fully retracted towards the front of the vehicle 200. During a routine refuse collection operation, the ejector 250 may be repeatedly extended (or partially extended) to transfer refuse from the hopper 234 to the storage container 236 and to further compact the refuse in the storage container 236. At the completion of such a compaction cycle, the ejector 250 is commonly returned to the retracted position (until the next compaction cycle is initiated). In normal operation, the ejector 250 executes numerous (e.g., tens or even hundreds of) compaction cycles prior to unloading the vehicle. It will, of course, be appreciated that routine translation of the ejector 250 during these compactions cycles is not intended to open the tailgate 220.

In the embodiment depicted on FIGS. 4 and 5, the cable 262 (or cables) includes slack (extra length) to accommodate translation of the ejector 250 during the compaction cycle(s). The slack is taken up by a tensioner pulley 282 and a corresponding spring 284 with the spring 284 being retracted when the ejector 250 is retracted (e.g., as depicted in FIG. 5A). During a compaction cycle the spring 284 is extended as the ejector 250 is extended rearward such that little or no force is applied to the tailgate 220 (e.g., as depicted on FIG. 5B). The tensioner pulley 282 and spring 284 may be configured to provide a predetermined length of slack and thereby permit a predetermined stroke length of the ejector 250 without significant opening force being applied to the tailgate 220. In one example embodiment, a stop (not depicted) may be deployed on the roof 238 (or elsewhere) to prevent further rearward motion of the tensioner pulley 282.

It will be appreciated that an intermediate ejector position (intermediate between the retracted and extended positions) may be defined by the configuration of the tensioner pulley 282 and spring 284 (e.g., when the spring 284 is fully extended as depicted on FIG. 5B or when the pulley 282 encounters a stop). Actuation force may be advantageously applied to the tailgate via the cable when (and optionally only when) the ejector is translated in the rearward direction beyond the intermediate position.

With continued reference to FIGS. 4 and 5, rearward extension of the ejector beyond an intermediate location fully extends spring 284 such that the cable 262 applies force to the hinge bracket 226. To open the tailgate, the locking system (if employed) is first released as described above. The ejector 250 is then translated rearward. The tailgate may start to open as the refuse in the storage container is compacted and applies force to the tailgate 220 as described above with respect to FIG. 3A. Extension of the ejector 250 beyond the intermediate location also transfers force to the tailgate 220 (via the cable 262 and hinge bracket 226). The system is configured such that full extension of the ejector 250 fully opens the tailgate (e.g., rotating the tailgate about hinge 222 as depicted on FIGS. 4C and 5C).

As described above with respect to FIGS. 3A and 3B, a portion of the tailgate opening force may be transferred to the tailgate 220 through the refuse 95 in the storage container 236. Certain embodiments of cabling system 260 may therefore be thought of as secondary or supplemental (in that it provides a supplemental force for opening the tailgate). In other embodiments, the cabling system 260 may be primary. In such embodiments, the cabling system may be intended to provide most (or all) of the force necessary to open the tailgate.

While FIG. 5 depicts a vehicle 200 including first and second cables 262 (along with first and second sets of pulleys and springs) deployed on opposite sides of the vehicle, it will be appreciated that the disclosed embodiments are not so limited. For example, vehicle 200 may alternatively include only a single cable routed through a single set of pulleys that runs along an approximate centerline of the roof 238 (e.g., in an embodiment in which the cabling system is intended to be secondary or supplemental as described above.

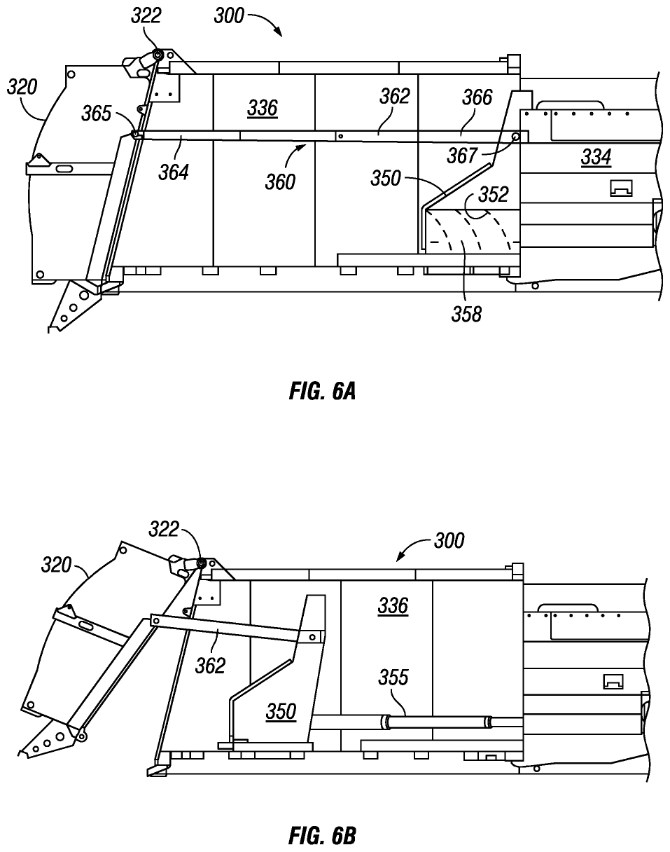

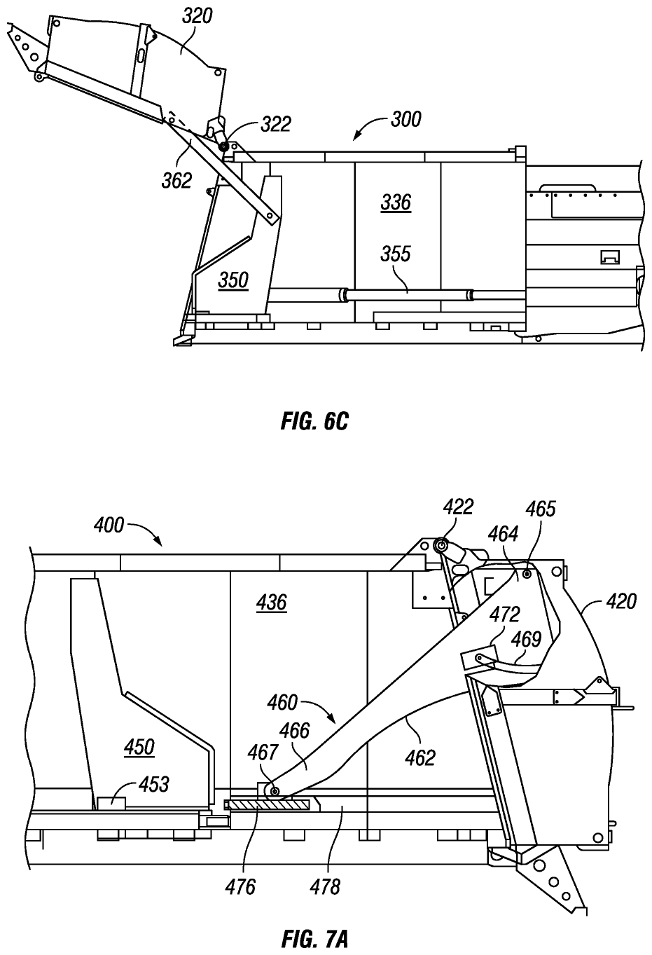

Turning now to FIGS. 6-8, alternative refuse vehicle embodiments 300, 400, and 500 are depicted including push bar tailgate actuation systems 360, 460, and 560 which are configured to transfer actuation force from the ejector to the tailgate and thereby open the tailgate. These systems include at least one push bar deployed between the tailgate and the ejector. The push bar is configured to engage (or couple) the ejector and the tailgate when the ejector is extended beyond an intermediate location towards the rear of the vehicle. As the ejector continues translating towards the rear of the vehicle, force is transferred through the push bar to the tailgate, thereby opening the tailgate (as depicted in FIGS. 6-8). In such embodiments, the push bar may be optionally further configured to support the weight of the tailgate in the open (or partially open) position and to pull the tailgate closed when the ejector is retracted.

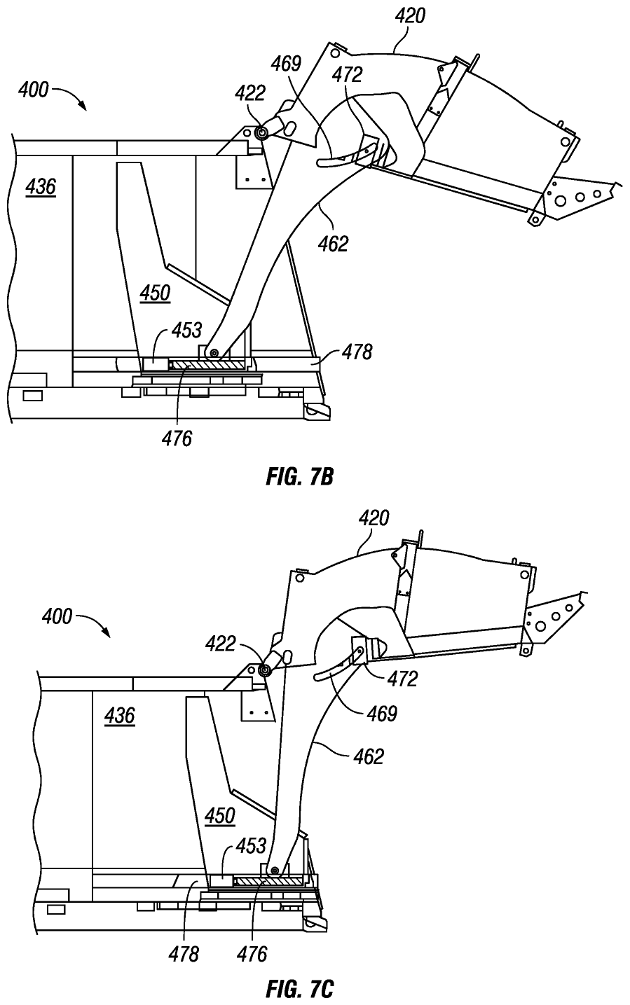

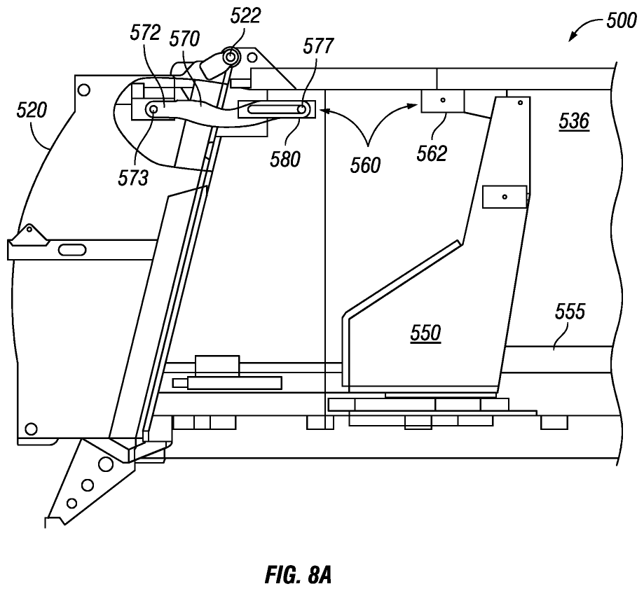

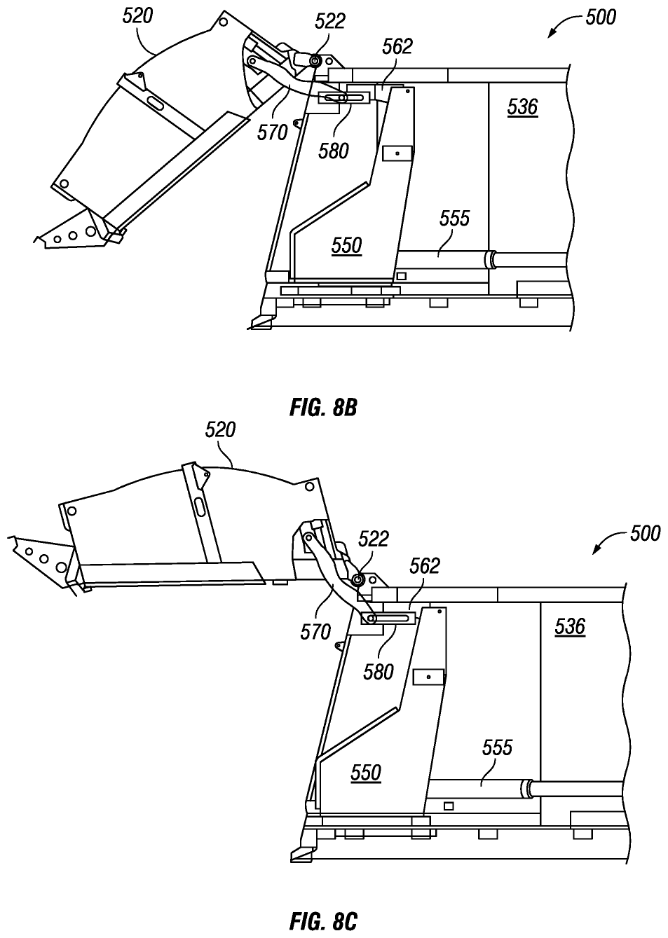

Three distinct push bar actuated embodiments are described in more detail below with respect to FIGS. 6-8. In the first embodiment (depicted on FIG. 6), a telescoping push bar is coupled to both the ejector and the tailgate. In the second embodiment (FIG. 7), the push bar is coupled to the tailgate and slidably engages a track along the interior side of the body. In the third embodiment (FIG. 8), the push bar is fixed to the ejector and engages a push bar link that is coupled to the tailgate.

FIGS. 6A-6C depict side views of refuse vehicle embodiment 300 including a push bar tailgate actuation system 360 configured to transfer actuation force from the ejector 350 to the tailgate 320 and thereby open the tailgate. Tailgate actuation system 360 includes a telescoping push bar 362, one end 364 of which is rotationally coupled (e.g., pinned) to the tailgate 320 (at 365) and the other end 366 of which is rotationally coupled (e.g., pinned) to the ejector 350 (at 367).

In FIG. 6A the tailgate 320 is closed with the ejector 350 retracted to the front of the storage container 336. The telescoping push bar 362 is extended. Although not depicted, the push bar may be deployed in a channel or pivoting channel located along an interior side wall of the storage container 336. An auger 358 extends from the hopper 334 through an opening 352 in the ejector 350. The ejector may optionally include a hatch or door (not depicted) for isolating the auger 358 from the storage container when ejecting a load. The disclosed embodiments are, of course, not limited in this regard.

Tailgate open and close functionality is now described in more detail. As described above, the ejector may be repeatedly extended (or partially extended) and retracted to compact refuse in the storage container during routine operation of the vehicle. In the depicted embodiment, telescoping push bar 362 is configured to accommodate these compaction cycles. During a compaction cycle the push bar 362 collapses as the actuator 355 pushes the ejector 350 rearward such that little or no force is applied to the tailgate 320. The telescoping push bar 362 then extends when the ejector retracts to its home position (FIG. 6A).

To open the tailgate, the locking system (if employed) is first released as described above. The ejector 350 is then actuated rearward. The tailgate may sometimes start to open as the refuse in the storage container is compacted and applies force to the tailgate 320 as described above with respect to FIG. 3A. Rearward extension of the ejector beyond an intermediate position fully collapses the telescoping push bar 362 (as depicted on FIGS. 6B and 6C) and thereby applies an opening force (or an additional opening force) to the tailgate 320. In the depicted embodiment the push bar 362 urges the tailgate 320 to rotate about hinge 322 to the open position. It will be appreciated that an intermediate ejector position (intermediate between the retracted and extended positions) may be defined by the configuration of the telescoping push bar 362 (e.g., when push bar is fully collapsed). Actuation force may be advantageously applied to the tailgate via the push bar when (and optionally only when) the ejector is translated in the rearward direction beyond the intermediate position.

The system is configured to fully open the tailgate 320 when the ejector 350 is fully extended (e.g., as depicted on FIG. 6C) with the push bar 362 pivoting with respect to the tailgate 320 and ejector 350 as depicted. It will be appreciated that the push bar 362 may be advantageously configured (e.g., having sufficient compressive and buckling strength) to hold the tailgate open.

To close the tailgate 320, the ejector 350 is retracted forward (e.g., allowing the tailgate to rotate downward under its own weight). When the tailgate 320 rotates to the closed position, continued retraction of the ejector 350 extends the telescoping push bar 362. The push bar may be configured (e.g., having an appropriate length and sufficient strength under tension) to pull the tailgate tightly shut and seal the storage container when the ejector 350 is fully retracted. The optional locking system may then be actuated to lock the tailgate in the closed position.

FIGS. 7A-7C depict side views of refuse vehicle embodiment 400 including a push bar tailgate actuation system 460 configured to transfer actuation force from the ejector 450 to the tailgate 420 and thereby open the tailgate. Tailgate actuation system 460 includes a push bar 462, one end 464 of which is rotatably coupled (at 465) to the tailgate. The push bar 462 is further coupled to the tailgate via a roller guide 472 mounted on the tailgate and received in a slot 469 in the push bar. The other end 466 (lower end in the depiction) of the push bar 462 is rotatably coupled (at 467) to a guide rail 476. The guide rail 476 is deployed in a corresponding track 478 which is mounted on an interior side of the body (e.g., at the bottom of the storage container 436 as depicted).

In FIG. 7A the tailgate 420 is closed with the ejector 450 being partially extended. Guide rail 476 is located at the forward end of the track 478 and roller guide 472 is located at a forward end of the push bar slot 469. The ejector 450 is disengaged from the push bar 462 and is free to extend and retract without applying opening force to the tailgate 420 via the push bar. For example, as described above, the ejector 450 may be retracted to a home position at the front of the storage container 436 or to a home position at the front of the hopper (depending upon whether or not an auger is deployed in the hopper). The ejector may be repeatedly extended (or partially extended) from the home position to transfer refuse from the hopper to the storage container 436 and/or to compact refuse in the storage container 436 without applying an opening force to the tailgate via the push bar 462.

To open the tailgate 420, the locking system (if employed) is first released as described above. The ejector 450 is then actuated rearward. The tailgate may sometimes start to open as the refuse in the storage container is compacted and applies force to the tailgate 420 as described above with respect to FIG. 3A. Rearward extension of the ejector 450 beyond an intermediate position causes an ejector tab 453 positioned on the ejector 450 to engage guide rail 476 and apply an opening force (or an additional opening force) to the tailgate 420. It will be appreciated that an intermediate ejector position (intermediate between the retracted and extended positions) may be defined by the configuration of the ejector 450, the tab 453, and the guide rail 476 (e.g., when the tab engages the guide rail). Actuation force may be advantageously applied to the tailgate via the push bar when (and optionally only when) the ejector is translated in the rearward direction beyond the intermediate position.

Continued actuation of the ejector moves the guide rail 476 towards the rear of the vehicle causing the push bar to open the tailgate 420 (FIGS. 7B and 7C). In the depicted embodiment the push bar urges the tailgate 420 to rotate about hinge 422 to the open position. The system is configured to fully open the tailgate 420 when the ejector 450 is fully extended (FIG. 7C) with the push bar 462 pivoting with respect to the both the tailgate 420 and the guide rail 476 as depicted, the guide rail sliding from the front of the track 478 to the back of the track 478, and the roller guide 472 rolling from a front end of the slot 469 to a back end of the slot 469. It will be appreciated that the push bar 462 may be advantageously configured (e.g., having sufficient compressive and buckling strength) to hold the tailgate open.

To close the tailgate 420, the ejector 450 is retracted forward (e.g., allowing the tailgate to rotate downward under its own weight). When the tailgate 420 rotates to the closed position, continued retraction of the ejector 450 disengages the ejector tab 453 from the guide rail 476. The ejector may continue to retract without further influence on the tailgate. An optional locking system may then be actuated to lock and seal the tailgate in the closed position.

FIGS. 8A-8C depict side views of refuse vehicle embodiment 500 including a push bar tailgate actuation system 560 configured to transfer actuation force from the ejector 550 to the tailgate 520 and thereby open the tailgate. Tailgate actuation system 560 includes a push bar 562 fixed to and configured to translate with the ejector 550 (via actuator 555). The actuation system 560 further includes a push bar link 570, one end 572 of which is rotatably coupled to the tailgate 520 (at 573) and another end of which is rotatably and slidably engaged with a track rail 580 (at 577). In the depicted embodiment the track rail 580 is mounted in or to an underside of the roof (e.g., along a center line of the roof on the inside of the storage container 536).

In FIG. 8A the tailgate 520 is closed with the ejector 550 being partially retracted. The push bar link is coupled to the forward end of the track rail 580. The push bar 562 (which is fixed to the ejector 550) is disengaged from the push bar link 570 and is free to extend and retract (with the ejector 550) without applying opening force to the tailgate 520. For example, as described above, the ejector 550 may be retracted to a home position at the front of the storage container 536 or to a home position at the front of the hopper (depending upon whether or not an auger is deployed in the hopper). The ejector 550 may be repeatedly extended (or partially extended) from the home position to transfer refuse from the hopper to the storage container 536 and/or to compact refuse in the storage container 536 without applying an opening force to the tailgate 520 via the push bar 562 and the push bar link 570.

To open the tailgate 520, the locking system (if employed) is first released as described above. The ejector 550 is then actuated rearward. The unlocked tailgate may sometimes start to open as the refuse in the storage container is compacted and applies force to the tailgate 520 as described above with respect to FIG. 3A. Rearward extension of the ejector 550 beyond an intermediate position causes the push bar 562 (which is fixed to the ejector 550) to engage the push bar link 570 (or a tab or engagement surface on the link which is not depicted) and apply an opening force (or an additional opening force) to the tailgate 520 via the push bar link 570. It will be appreciated that an intermediate ejector position (intermediate between the retracted and extended positions) may be defined by the configuration of the push bar 562, the push bar link 570, and the guide rail 580 (e.g., when the push bar engages the push bar link). Actuation force may be advantageously applied to the tailgate via the push bar and push bar link when (and optionally only when) the ejector is translated in the rearward direction beyond the intermediate position.

Continued actuation of the ejector moves the push bar link 570 in the track rail 580 towards the rear of the vehicle causing the push bar link 570 to open the tailgate 520 (e.g., rotate the tailgate 520 about hinge 522 as depicted on FIGS. 8B and 8C). The system is configured to fully open the tailgate 520 when the ejector 550 is fully extended (FIG. 8C) with the push bar link 570 pivoting with respect to the both the tailgate 520 and the track rail 580 as depicted and the push bar link 570 moving to the back end of the track rail 580. It will be appreciated that the push bar 562 and the push bar link 570 may be advantageously configured (e.g., having sufficient compressive and buckling strength) to hold the tailgate open.

To close the tailgate 520, the ejector 550 is retracted forward (e.g., allowing the tailgate to rotate downward under its own weight). When the tailgate 520 rotates to the closed position, continued retraction of the ejector 550 disengages the push bar 562 from the push bar link 570. The ejector may continue to retract without further influence on the tailgate. An optional locking system may then be actuated to lock and seal the tailgate in the closed position.

With continued reference to FIGS. 6-8, it will be appreciated that refuse vehicles 300, 400, and 500 may include symmetric tailgate actuation systems 360, 460, and 560 deployed on opposing sides of the vehicle body (e.g., on the driver and passenger sides of the body). In other words, the refuse vehicles may include first and second push bars located on opposing sides of the vehicle and configured to transfer actuation force from the ejector actuator to the tailgate via the ejector. Those of ordinary skill will readily appreciate that a vehicle employing symmetric systems may provide better support and stability for the tailgate and thereby reduce stress in the hinge and reduce the likelihood of twisting when opening and/or closing.

While vehicles 300, 400, and 500 may include symmetric tailgate actuation systems, it will be understood that the disclosed embodiments are not so limited. These vehicles may also include a single tailgate actuation system deployed on one side of the vehicle (or along a center line of the vehicle). For example, actuation system 560 in vehicle 500 may be advantageously deployed along a center line of the vehicle.

Although ejector actuation of a refuse vehicle tailgate has been described in detail, it should be understood that various changes, substitutions and alternations can be made herein without departing from the spirit and scope of the disclosure as defined by the appended claims.

What is claimed is:

1. A refuse vehicle body comprising:
a tailgate coupled to the body, the tailgate movable between a closed position and an open position;
an ejector deployed in the body, the ejector configured to translate between forward and rearward positions in a direction parallel to a longitudinal axis of the body; and
an actuator configured to translate the ejector between the forward and rearward positions in the body, the actuator further configured to provide an actuation force that moves the tailgate from the closed position towards the open position and thereby at least partially opens the tailgate.

2. The refuse vehicle body of claim 1, wherein the ejector is configured to cause the actuation force to be applied to the tailgate in response to translation of the ejector towards the rearward position beyond an intermediate position.

3. The refuse vehicle body of claim 2, wherein the ejector is configured to compact the refuse in the body into contact with the tailgate, thereby causing at least a portion of the actuation force to be applied to the tailgate through the refuse in response to translation of the ejector beyond the intermediate position.

4. The refuse vehicle body of claim 1, wherein:
the tailgate is hinged to the body and rotatable between the closed and the open positions; and
the body further comprises a winch mounted on a top exterior side of the body, the winch including an electric actuator and a cable connected to the tailgate, the winch configured to provide a supplementary actuation force to the tailgate through the cable to rotate the tailgate towards the open position.

5. The refuse vehicle body of claim 1, wherein the ejector is configured to cause the tailgate to be moved to the open position in response to translation of the ejector to the rearward position, and wherein the actuator is an electrically powered linear actuator.

6. The refuse vehicle body of claim 1, wherein the tailgate is hinged to the body and rotatable between the closed and the open positions.

7. The refuse vehicle body of claim 1, wherein the ejector is configured to: 1) compact refuse in a storage container when the tailgate is in the closed position, and 2) eject the refuse from the storage container when the tailgate is at least partially open in response to translation of the ejector towards the rearward position.

8. The refuse vehicle body of claim 1, further comprising:
a hopper configured to receive refuse; and
a storage container configured to store compacted refuse,
wherein the ejector is configured to transfer the refuse from the hopper to the storage container, compact the refuse in the storage container, and eject the compacted refuse from the storage container.

9. The refuse vehicle body of claim 1, further comprising:
a hopper configured to receive refuse;
a storage container configured to store compacted refuse; and
an auger deployed in the hopper and configured to transfer the refuse from the hopper to the storage container,
wherein the ejector is configured to eject the compacted refuse from the storage container.

10. The refuse vehicle body of claim 1, further comprising a locking assembly configured to lock the tailgate in the closed position.

11. The refuse vehicle body of claim 1, mounted to a vehicle chassis.

12. A refuse vehicle body comprising:
a tailgate coupled to the body, the tailgate movable between a closed position and an open position;
an ejector deployed in the body, the ejector configured to translate between forward and rearward positions in a direction parallel to a longitudinal axis of the body;
an actuator configured to translate the ejector between the forward and rearward positions in the body; and
a tailgate actuation system configured to transfer a force from the actuator, via the ejector, to the tailgate when the ejector is translated towards the rearward position, thereby moving the tailgate from the closed position to the open position.

13. The refuse vehicle body of claim 12, wherein the tailgate actuation system comprises a push bar rotatably coupled to the tailgate and the ejector, the push bar configured to transfer the force.

14. The refuse vehicle body of claim 13, wherein the push bar is configured to transfer the force only when the ejector translates towards the rearward position beyond an intermediate position.

15. The refuse vehicle body of claim 14, wherein the push bar is a telescoping push bar, and wherein the ejector is configured to collapse the telescoping push bar, thereby causing the collapsed push bar to transfer the force in response to translation of the ejector towards the rearward position beyond the intermediate position.

16. The refuse vehicle body of claim 12, wherein the tailgate actuation system further comprises a guide rail translatable in a track, the track on an interior side of the body, and wherein the push bar is rotatably coupled to the tailgate and the guide rail.

17. The refuse vehicle body of claim 16, wherein the ejector is configured to engage the guide rail, thereby causing the push bar to transfer the force in response to translation of the ejector towards the rearward position beyond an intermediate position.

18. The refuse vehicle body of claim 12, wherein the tailgate actuation system comprises a cable coupled to the ejector and the tailgate, the cable being configured to transfer the force, wherein the cable is routed along an external top side of the body.

19. The refuse vehicle body of claim 18, wherein the cable is routed through at least one spring-biased tensioner pulley, the spring-biased tensioner pulley configured to accommodate translation of the ejector in the rearward position to an intermediate position without causing the cable to apply the force.

20. The refuse vehicle body of claim 19, wherein the ejector is configured to fully extend the spring-biased tensioner pulley, thereby causing the cable to apply the force in response to translation of the ejector towards the rearward position beyond the intermediate position.
